(19) United States
(12) Patent Application Publication
(10) Pub. No.: US 2018/0304792 A1
(43) Pub. Date: Oct. 25, 2018

(54) Car Table Clipboard Combo

(71) Applicant: Theodore Syrianos, Sag Harbor, NY (US)

(72) Inventor: Theodore Syrianos, Sag Harbor, NY (US)

(21) Appl. No.: 15/909,100

(22) Filed: Mar. 1, 2018

Related U.S. Application Data
(60) Provisional application No. 62/488,046, filed on Apr. 20, 2017.

(51) Int. Cl. B60N 3/00; B42F 9/00

(52) U.S. Cl. CPC B60N 3/005; B42F 9/002

(57) ABSTRACT

A portable multi-purpose motor vehicle surface system (Car Table Clipboard Combo) includes a surface assembly including a rigid platform having a first-surface and a second-surface, an elongated aperture, a writing implement holder, a clamping-member, and a securer. The portable multi-purpose motor vehicle surface system provides a flat surface that is attachable to a circular steering wheel of a motor vehicle with an integrated clipboard and writing implement holder.

### CROSS REFERENCE TO RELATED APPLICATION

The present application is related to and claims priority to U.S. Provisional Patent Application No. 62/488,046 filed Apr. 20, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of portable work surfaces and more specifically relates to a portable work surface for use in a motor vehicle.

### 2. Description of Related Art

Many people spend a lot of time in their vehicle. They may need an area to write or perform other tasks while seated in a driver's seat. When sitting in a vehicle, it can be difficult to find a flat surface to write on, rest a computer on, or eat on. Individuals may have to balance their computer or lunch on their lap and may have to use the dashboard as a writing surface. These options are not ideal and can be frustrating for the user. An effective alternative is needed.

U.S. Pat. No. 6,036,158 to Matthew E. Raasch relates to a portable steering wheel mounted tray. The described portable steering wheel mounted tray includes a portable, rigid tray that may be attached to a steering wheel of a motor vehicle for use as a surface for writing, drawing, using laptop computers and the like. The tray has a generally flat upper surface and a lower surface bound by a distal end, proximal end and opposing side ends. An elongated opening located near the distal end is sized and configured to slide over the top of the typical steering wheel to support the tray at the opposing curved side edges, distal side edge and proximal side edge. An angular member attached to or integral with the lower surface at the proximal side edge causes the tray to extend outwardly and downwardly from the plane of the steering wheel to provide a comfortable, convenient and easy to access work surface for the user sitting in front of the vehicle steering wheel. Other than a spring-loaded clip which can be added to the upper surface of the tray, the tray does not utilize any moving parts, allowing it to be molded from a single piece of plastic or other material.

### BRIEF SUMMARY OF THE INVENTION

In view of the foregoing disadvantages inherent in the known portable work surface art, the present disclosure provides a novel portable multi-purpose motor vehicle surface system. The general purpose of the present disclosure, which will be described subsequently in greater detail, is to provide a multi-purpose motor vehicle surface which may be attached to a steering wheel and provide a portable working surface.

A portable multi-purpose motor vehicle surface system is disclosed herein. The portable multi-purpose motor vehicle surface system includes a surface assembly including a rigid platform having a first-surface and a second-surface, an elongated aperture, a writing implement holder, a clamping-member, and a securer. The surface assembly comprises the rigid platform, the elongated aperture, the writing implement holder, the clamping-member, and the securer in functional combination. The portable multi-purpose motor vehicle surface system provides a flat surface that is attachable to a circular steering wheel of a motor vehicle with an integrated clipboard and writing implement holder.

The rigid platform comprises the first-surface and the second-surface together configured to provide a planar work surface. The first-surface comprises the writing implement holder and the clamping-member. The second-surface does not comprise attachments and provides the planar work surface. The second-surface may be used as an eating platform and the first-surface may be used as a writing platform.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable multi-purpose motor vehicle surface system, entitled ‘Car Table Clipboard Combo’, constructed and operative according to the teachings of the present disclosure.

FIG. 1 is a front perspective view of the portable multi-purpose motor vehicle surface system during an ‘in-use’ condition, according to an embodiment of the disclosure.

FIG. 2 is a front perspective view of the portable multi-purpose motor vehicle surface system of FIG. 1, according to an embodiment of the present disclosure.

FIG. 3 is a front perspective view of the portable multi-purpose motor vehicle surface system of FIG. 1, according to an embodiment of the present disclosure.

FIG. 4 is a front perspective view of the portable multi-purpose motor vehicle surface system of FIG. 1, according to an embodiment of the present disclosure.

FIG. 5 is a flow diagram illustrating a method of use for the portable multi-purpose motor vehicle surface system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a portable work surface and more particularly to a portable multi-purpose motor vehicle surface system as used to improve the usage and availability of usable surfaces in a motor vehicle.

Generally, the present invention provides a flat surface that is attachable to a vehicle steering wheel with an integrated clipboard and pen holder. One side of the device is the clip board and the other side is the table; simply flip the device to the side you wish to use. It attaches over a vehicle steering wheel, which holds it in place to allow a user to write on it or use it as a table. As designed, it incorporates a standard clipboard clip for holding items and a pen clip to secure a pen to the surface. It includes a large pair of attachable spring-loaded clips to be placed over larger items when moving the surface. The present invention enables users to use the surface as a work tray or lunch tray depending on its position.

The portable multi-purpose motor vehicle surface system offers users a writing surface, work surface, and eating surface that can be attached to a vehicle steering wheel. The device is comprised of a flat surface attachable to the steering wheel via a cutout portion that doubles as a handle. The surface includes an integrated clipboard and penholder. The device attaches over top of the steering wheel. The system also includes an additional pair of spring-loaded clips to hold larger items in place when removing the device from the steering wheel. One side of the device is the clip board and the other side is the table; simply flip the device to the side you wish to use. The exact specifications may vary.

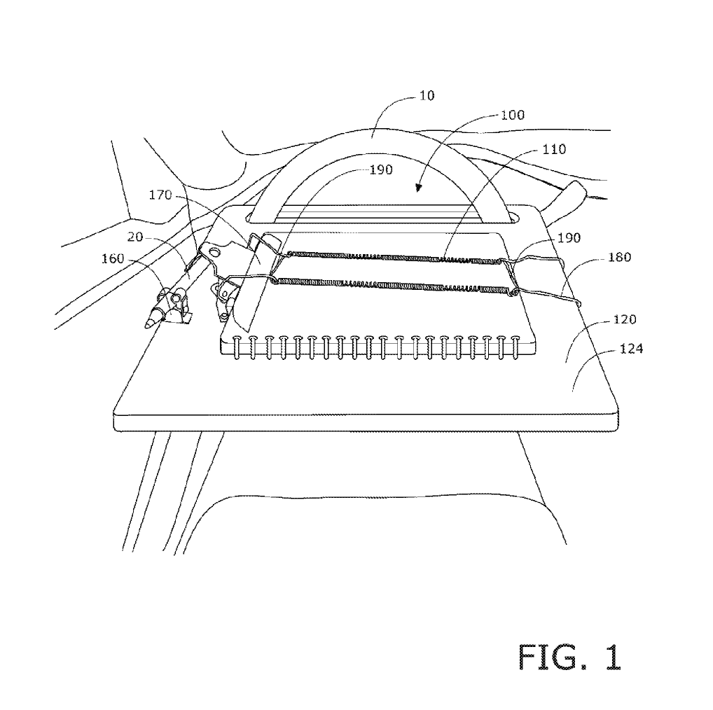

Referring now more specifically to the drawings by numerals of reference, there is shown in FIGS. 1-5, various views of a portable multi-purpose motor vehicle surface system 100. FIG. 1 shows a portable multi-purpose motor vehicle surface system 100 during an ‘in-use’ condition 150, according to an embodiment of the present disclosure. As illustrated, the portable multi-purpose motor vehicle surface system 100 may include a surface assembly 110 including a rigid platform 120 having a first-surface 124 and a second-surface 130, an elongated aperture 140, a writing implement holder 160, a clamping-member 170, and a securer 180. The surface assembly 110 comprises the rigid platform 120, the elongated aperture 140, the writing implement holder 160, the clamping-member 170, and the securer 180 in functional combination. The portable multi-purpose motor vehicle surface system 100 provides a flat surface that is attachable to a circular steering wheel 10 of a motor vehicle with an integrated clipboard and writing implement holder 160.

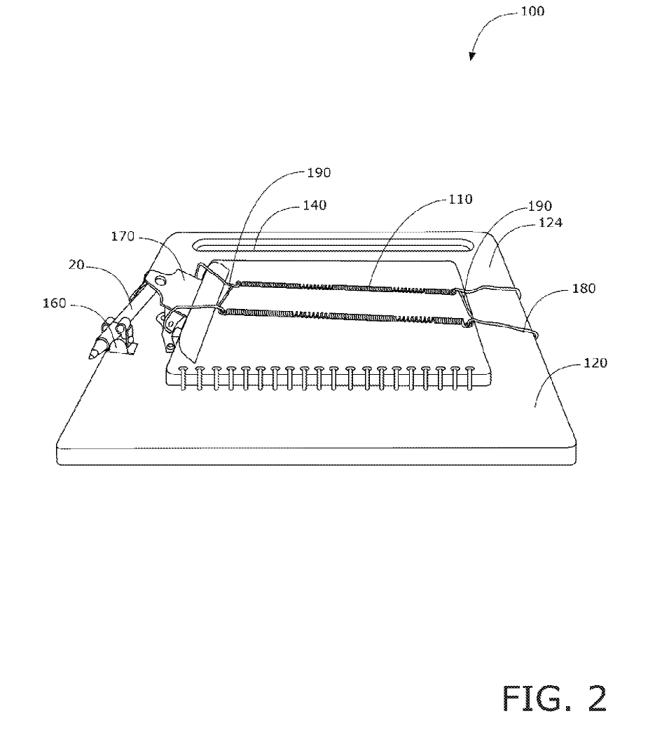

FIG. 2 shows a perspective view of the portable multi-purpose motor vehicle surface system 100 of FIG. 1, according to an embodiment of the present disclosure. As above, the portable multi-purpose motor vehicle surface system 100 may include the rigid platform 120, the elongated aperture 140, the writing implement holder 160, the clamping-member 170, and the securer 180. The rigid platform 120 comprises the first-surface 124 and the second-surface 130 configured to provide a planar work surface. The first-surface 124 comprises the writing implement holder 160 and the clamping-member 170. The second-surface 130 does not comprise attachments in preferred embodiments and provides the planar work surface. The second-surface 130 may be used as an eating platform and the first-surface 124 may be used as a writing platform. The surface assembly 110 provides a planar work surface for use. The writing-implement 20 is removably coupleable within the writing implement holder 160. The writing-implement 20 may include a pen, pencil, stylus, or other writing-implement 20.

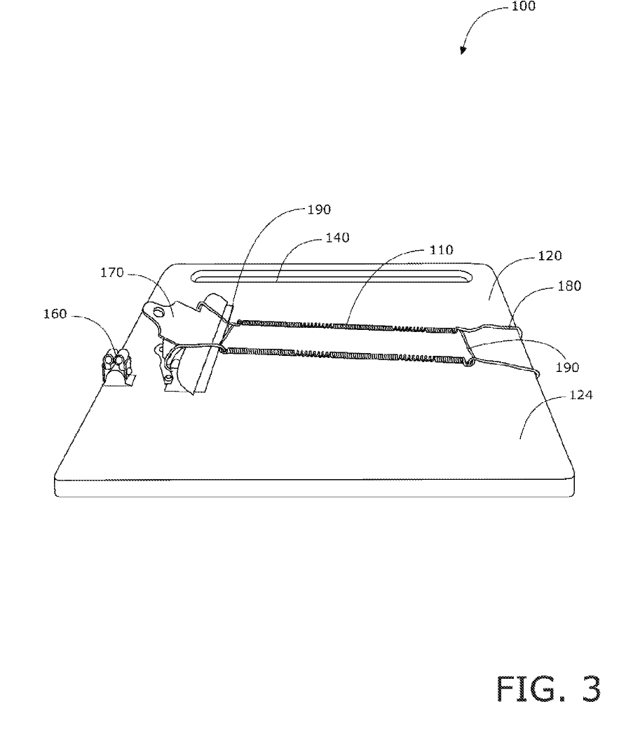

FIG. 3 shows a perspective view of the portable multi-purpose motor vehicle surface system 100 of FIG. 1, according to an embodiment of the present disclosure. As above, the portable multi-purpose motor vehicle surface system 100 may include the rigid platform 120 which comprises the first-surface 124 and the second-surface 130 configured to provide a planar work surface. The first-surface 124 comprises the writing implement holder 160 and the clamping-member 170. The clamping-member 170 is configured to secure at least one item. The items secured by the clamping-member 170 may include a notepad, documents, a notebook, a book or other suitable item. The securer 180 is configured to further secure at least one item supported by the clamping-member 170. The securer 180 comprises a first-end and a second-end, the first-end affixed to the clamping-member 170, the second-end configured to affix to an outer edge of the rigid platform 120. The securer 180 may include hooks at the second-end configured to affix to the outer edge of the rigid platform 120. The securer 180 is spring-loaded and comprises perpendicular support-members 190. The securer 180 is normally in tension.

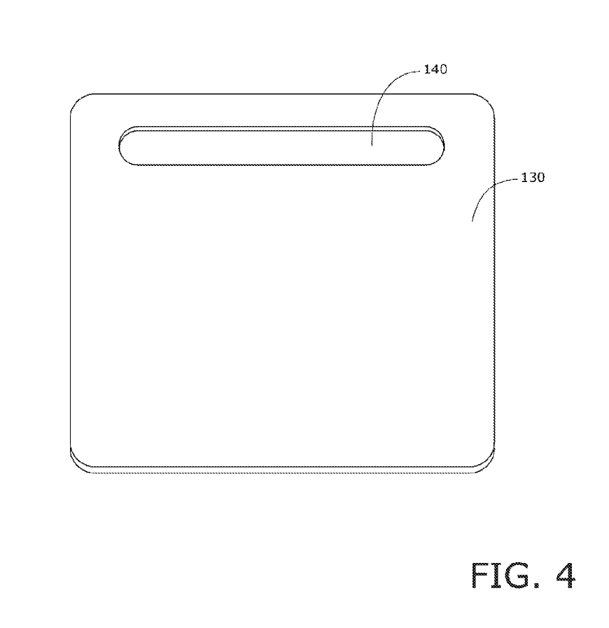

FIG. 4 shows a perspective view of the portable multi-purpose motor vehicle surface system 100 of FIG. 1, according to an embodiment of the present disclosure. As above, the portable multi-purpose motor vehicle surface system 100 may include the elongated aperture 140. The elongated aperture 140 is configured to receive a circular steering wheel 10 of a motor vehicle and support the rigid platform 120 in a substantially horizontal position, as shown. The elongated aperture 140 comprises a length less than a width of the circular steering wheel 10 of the motor vehicle. The elongated aperture 140 comprises rounded portions at opposing interior ends. The elongated aperture 140 is positioned at an upper portion of the rigid platform 120. The elongated aperture 140 is configured to provide means for carrying the surface assembly 110. The elongated aperture 140 may extend along a top the outer edge of the rigid platform 120.

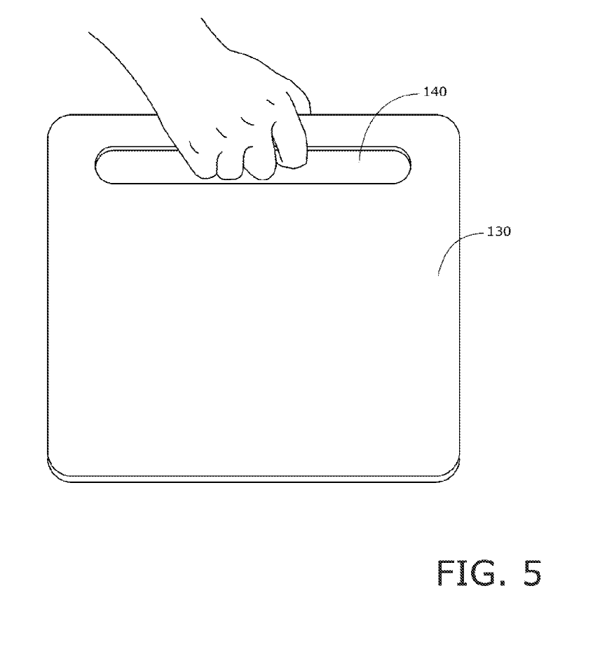

FIG. 5 shows a perspective view of the portable multi-purpose motor vehicle surface system 100 of FIG. 1, according to an embodiment of the present disclosure. As above, the portable multi-purpose motor vehicle surface system 100 may include the rigid platform 120, the elongated aperture 140, the writing implement holder 160, the clamping-member 170, and the securer 180. The rigid platform 120 comprises a substantially rectangular profile and may be made from wood, plastic, metal, or other suitable rigid materials. The rigid platform 120 is configured to be rotated and secured to the circular steering wheel 10 of the motor vehicle for access to the first-surface 124 and the second-surface 130 alternatively. The bottom of the outer edge is proximate to a user during an in-use condition.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable multi-purpose motor vehicle surface system comprising:
a surface assembly including;
a rigid platform having;
a first-surface; and
a second-surface;
an elongated aperture;
a writing implement holder;
a clamping-member; and
a securer;
wherein said surface assembly comprises said rigid platform, said elongated aperture, said writing implement holder, said clamping-member, and said securer in functional combination;
wherein said rigid platform comprises said first-surface and said second-surface configured to provide a planar work surface;
wherein said first-surface comprises said writing implement holder and said clamping-member;
wherein said elongated aperture is configured to receive a circular steering wheel of a motor vehicle and support said rigid platform in a substantially horizontal position;
wherein said securer is configured to further secure at least one item supported by said clamping-member; and
wherein said surface assembly provides said planar work surface for use.

2. The portable multi-purpose motor vehicle surface system of claim 1, wherein said elongated aperture comprises a length less than a width of said circular steering wheel of said motor vehicle.

3. The portable multi-purpose motor vehicle surface system of claim 2, wherein said elongated aperture comprises rounded portions at opposing interior ends.

4. The portable multi-purpose motor vehicle surface system of claim 1, wherein said elongated aperture is positioned at an upper portion of said rigid platform.

5. The portable multi-purpose motor vehicle surface system of claim 4, wherein said elongated aperture is configured to provide means for carrying said surface assembly.

6. The portable multi-purpose motor vehicle surface system of claim 1, wherein said securer comprises a first-end and a second-end, said first-end affixed to said clamping-member, said second-end configured to affix to an outer edge of said rigid platform.

7. The portable multi-purpose motor vehicle surface system of claim 6, wherein said securer comprises hooks at said second-end configured to affix to said outer edge of said rigid platform.

8. The portable multi-purpose motor vehicle surface system of claim 7, wherein said securer is spring-loaded.

9. The portable multi-purpose motor vehicle surface system of claim 1, wherein said securer comprises perpendicular support-members.

10. The portable multi-purpose motor vehicle surface system of claim 1, wherein said rigid platform comprises a substantially rectangular profile.

11. The portable multi-purpose motor vehicle surface system of claim 10, wherein said rigid platform comprises a material selected from a group consisting of wood, plastic, and metal.

12. The portable multi-purpose motor vehicle surface system of claim 1, wherein said rigid platform is configured to be rotated and secured to said circular steering wheel of said motor vehicle for access to said first-surface and said second-surface alternatively.

13. The portable multi-purpose motor vehicle surface system of claim 2, wherein said elongated aperture extends along a top said outer edge of said rigid platform.

14. The portable multi-purpose motor vehicle surface system of claim 1, wherein a bottom of said outer edge is proximate to a user during an in-use condition.

15. The portable multi-purpose motor vehicle surface system of claim 1, wherein said at least one item is selected from a group consisting of a notepad, documents, a notebook, and a book.

16. The portable multi-purpose motor vehicle surface system of claim 1, wherein a writing-implement is removeably coupleable within said writing implement holder.

17. The portable multi-purpose motor vehicle surface system of claim 16, wherein said writing-implement is selected from a group consisting of a pen, pencil, and stylus.

18. The portable multi-purpose motor vehicle surface system of claim 1, wherein said second-surface does not comprise attachments and provides said planar work surface.

19. The portable multi-purpose motor vehicle surface system of claim 1, wherein said securer is normally in tension.

20. A portable multi-purpose motor vehicle surface system comprising:
a surface assembly including;
a rigid platform having;
a first-surface; and
a second-surface;
an elongated aperture;
a writing implement holder;
a clamping-member; and
a securer;
wherein said surface assembly comprises said rigid platform, said elongated aperture, said writing implement holder, said clamping-member, and said securer in functional combination;
wherein said rigid platform comprises said first-surface and said second-surface configured to provide a planar work surface;
wherein said rigid platform comprises a substantially rectangular profile;
wherein said rigid platform is configured to be rotated and secured to said circular steering wheel of said motor vehicle for access to said first-surface and said second-surface alternatively;
wherein said elongated aperture extends along a top said outer edge of said rigid platform;
wherein a bottom of said outer edge is proximate to a user during an in-use condition;
wherein said first-surface comprises said writing implement holder and said clamping-member;
wherein said second-surface does not comprise attachments and provides said planar work surface;
wherein a writing-implement is removeably coupleable within said writing implement holder;
wherein said elongated aperture is configured to receive a circular steering wheel of a motor vehicle and support said rigid platform in a substantially horizontal position;
wherein said elongated aperture comprises a length less than a width of said circular steering wheel of said motor vehicle;
wherein said elongated aperture comprises rounded portions at opposing interior ends;
wherein said elongated aperture is positioned at an upper portion of said rigid platform;
wherein said elongated aperture is configured to provide means for carrying said surface assembly;
wherein said securer is configured to further secure at least one item supported by said clamping-member;
wherein said securer comprises a first-end and a second-end, said first-end affixed to said clamping-member, said second-end configured to affix to an outer edge of said rigid platform;
wherein said securer comprises hooks at said second-end configured to affix to said outer edge of said rigid platform;
wherein said securer is spring-loaded;
wherein said securer comprises perpendicular support-members;
wherein said securer is normally in tension; and
wherein said surface assembly provides said planar work surface for use.
